(19) United States
(12) Patent Application Publication
(10) Pub. No.: US 2010/0059391 A1
(43) Pub. Date: Mar. 11, 2010

(54) METHOD FOR DETECTING BIOMOLECULES AND USE THEREOF

(75) Inventors: Jackie Y. Ying, Nanos (SG); Jie Zhang, Nanos (SG); Zhiqiang Gao, Nanos (SG); Boon Ping Ting, Nanos (SG)

Correspondence Address: COHEN, PONTANI, LIEBERMAN & PAVANE LLP, 551 FIFTH AVENUE, SUITE 1210, NEW YORK, NY, 10176, US

(73) Assignee: Agency for Science, Technology and Research, Connexis (SG)

(21) Appl. No.: 12/540,669

(22) Filed: Aug. 13, 2009

Related U.S. Application Data
(60) Provisional application No. 61/136,142, filed on Aug. 14, 2008.

(51) Int. Cl. G01N 27/26

(52) U.S. Cl. 205/792; 204/403.01

(57) ABSTRACT

Biomolecule-specific probe is immobilized on an electrode surface to form a modified electrode. The modified electrode is exposed to target biomolecule. The biomolecule is captured by the probe whereby a first complex with the biomolecule is formed. Subsequently, the biomolecule is exposed to electroactive label having binding affinity to the biomolecule. The biomolecule adsorbs the electroactive label to the modified electrode to form a working electrode whereby a second complex comprising the first complex with the biomolecule and the bound electroactive label is formed. The working electrode is placed in an electrolyte medium and electrochemical measurement between the working electrode and a reference electrode is taken wherein the electrochemical measurement comprises the measurement of electrical signal resulting from a solid-state electrochemical process involving the electroactive labels. The magnitude of the electrochemical measurement corresponds to the concentration of the biomolecule present in the sample.

This application claims priority of U.S. Provisional Application No. 61/136,142, filed Aug. 14, 2008, the contents of which are incorporated herein by reference.

Throughout this application, various publications are cited. The disclosure of these publications is hereby incorporated by reference into this application to describe more fully the state of the art to which this application pertains.

### FIELD OF INVENTION

The invention relates to a method for detecting biomolecules, such as DNA and protein tumor markers, in a sample, and in particular, to an electrochemical method therefor. The method is suitable for use in diagnostic kits for DNA and protein tumor markers.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

DNA detection has become increasingly important as the structure, organization, sequence and function of nucleic acid molecules are better understood. Detection of specific DNA sequences is needed in many areas, such as in diagnostic tests for mutation and early cancer detection, analysis of gene sequences, forensic investigation, assessment of medical treatment, and detection of environmental hazards and biological warfare agents. It therefore holds enormous potential for the development of new and specific therapeutic procedures, new drug research and development, gene therapy, food technology, and environmental sciences.

DNA biosensors or detectors based on nucleic acid hybridization have been vigorously studied and developed to identify specific DNA sequences. DNA biosensors are generally defined as analytical devices incorporating a single-stranded oligonucleotide (probe) intimately associated with or integrated within a physicochemical transducer, which may be optical, electrochemical, thermometric, piezoelectric, magnetic or micromechanical. A basic DNA biosensor is designed by the immobilization of a probe on a transducer (electrode) surface to recognize and capture its complementary DNA sequence (target) via hybridization. The DNA duplex formed on the electrode surface is known as a hybrid. This event is then converted into an analytical signal for measurement and detection. Consequently, a wide variety of DNA biosensors based on different detection strategies have been developed. Electrochemical DNA biosensors are of particular interest due to its low costs, simplicity, prompt detection, high sensitivity and amenability to miniaturization on a chip.

Immunosensors are a subset of biosensors. An immunosensor is a particular type of biosensor in which an antibody serves as the biological probe for a target antigen. An immunosensor is also commonly known as protein biosensor and works in a similar way as a DNA biosensor, except that the interaction between the antibody and the antigen is being converted into an analytical signal for measurement and detection.

Antibodies are produced in the human body to inactivate foreign substances by irreversibly combining with or binding the foreign substance to form a complex. An almost unlimited variety of antibodies are produced, each specific to a particular foreign substance. For example, prostate-specific antigen (PSA) is a 33 kDa glycoprotein in the human serum that has been commonly used as a tumor marker for detecting prostate cancer. After successful treatments such as radical prostatectomy, the PSA level should ideally be zero. Any measureable increase in the PSA level is an early sign of relapse. As a result, various PSA detection techniques have been developed over the years, including fluorescence measurement, surface plasmon resonance measurement, bio-barcode DNA measurement, electrochemical measurement, microcantilever bending measurement and nanowire conductance measurement. Of these techniques, electrochemical protein biosensors are of particular interest due to its low costs, simplicity, prompt detection, high sensitivity and amenability to miniaturization on a chip.

The aim of a DNA biosensor or a protein biosensor usually is to produce either discrete or continuous measurable signals, which are proportional to the concentration of the target DNA sequence or the target antigen. However, the concentration of such targets is usually very low in biological samples, making it unsuitable for detection by a basic DNA biosensor or protein biosensor without amplification of the measurable signals.

In order to achieve high detection sensitivity, researchers have developed many techniques to enhance or amplify the response of DNA biosensors by modifying the biosensors with different functional materials. Electroactive metallic nanoparticles and quantum dots have been employed as electroactive labels to amplify the electrochemical signal for measurement and detection. Two types of detection strategies have been commonly adopted. In the first strategy, the metallic nanoparticle labels are oxidatively dissolved using a strong oxidant, such as HBr/Br₂, and then stripping voltammetry is used to detect the dissolved metallic ions. The second strategy involves the collection of metallic nanoparticle label-DNA-magnetic bead conjugates with a specially designed magnetic electrode surface. The hybridization step in solution is followed by direct electrode oxidative detection of the metallic nanoparticles. Alternatively, chemical reductive growth of bare Ag nanoparticles from Ag⁺ interacting with the negatively charged DNA can also be followed by a direct electrochemically oxidative detection of the metallic nanoparticles.

Similar to the developments in DNA biosensors, different strategies were employed to increase the sensitivity of the protein biosensors by modifying the biosensors with different functional materials. For example, carbon nanotube amplification strategies were used to increase the loading of enzyme horseradish peroxidase (Yu et al., J. Am. Chem. Soc. 2006, 128, 11199-11205). In another attempt, gold nanoparticles instead of enzymes were used to catalytically reduce p-nitrophenol to p-aminophenol to achieve signal amplification (Das et al, J. Am. Chem. Soc. 2006, 128, 16022-16023).

Although the above detection strategies have enabled the electrochemical signals of the electroactive metallic labels to be amplified, a small signal would nonetheless be difficult to be distinguished from the background noises. Interferences may originate from many sources, such as non-hybridized DNA, electrode surface functional groups (especially in the case of carbon materials), solvents, electrolytes, dissolved oxygen, and electroactive labels strongly adsorbed to the electrode surface, which cannot be completely removed during the washing step. Most of these interferences cannot be avoided. Such interferences may not be important when the signal measured is high. However, the signal involved in DNA or protein detection is typically small. Further, with the use of strong oxidant such as HBr/Br₂, the electrode might be damaged in this medium under severe conditions.

Therefore, it is desirable to provide for an ultrasensitive electrochemical method for detecting DNA and other biomolecules (such as protein markers) that overcomes, or at least alleviates, the above problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In a first aspect of the present invention, there is provided a method for detecting the presence of a target biomolecule in a sample, comprising:
contacting the sample with a modified electrode, wherein the modified electrode has a biomolecule-specific probe immobilized on its surface and the biomolecule-specific probe is capable of forming a first complex with the target biomolecule present in the sample;
contacting the modified electrode with an electroactive label having a binding affinity to the target biomolecule to form a second complex, wherein the second complex comprises the first complex with the target biomolecule and the bound electroactive label, and whereby the modified electrode thus formed constitutes a working electrode;
placing the working electrode in an electrolyte medium; and
taking electrochemical measurement between the working electrode and a reference electrode
   wherein the electrochemical measurement comprises the measurement of electrical signal resulting from a solid-state electrochemical process involving the electroactive labels and whereby the magnitude of the electrochemical measurement corresponds to the concentration of the target biomolecule present in the sample.

In a second aspect of the present invention, there is provided the use of the method in accordance with the first aspect in diagnostic kits for DNA and protein tumor markers.

In a third aspect of the present invention, there is provided an electrode for use in the detection of the presence of a target biomolecule in a sample, comprising a biomolecule-specific probe immobilized on a surface of the electrode wherein the biomolecule-specific probe is capable of forming a first complex with the target biomolecule present in the sample. The electrode further comprises a second complex, wherein the second complex comprises the first complex with the target biomolecule and an electroactive label bound to the first complex with the target biomolecule.

In a fourth aspect of the present invention, there is provided a biosensor for detecting the presence of a target biomolecule in a sample, the biosensor comprising:
an electrode comprising a biomolecule-specific probe immobilized on a surface of the electrode wherein the biomolecule-specific probe is capable of forming a first complex with the target biomolecule present in the sample, and further comprising a second complex, wherein the second complex comprises the first complex with the target biomolecule and an electroactive label bound to the first complex with the target biomolecule, the electrode being placed in an electrolyte medium; and
an electrochemical measuring device for taking electrochemical measurement between the electrode and a reference electrode
   wherein the electrochemical measurement comprises the measurement of electrical signal resulting from a solid-state electrochemical process involving the electroactive labels and whereby the magnitude of the electrochemical measurement corresponds to the concentration of the target biomolecule present in the sample.

### BRIEF DESCRIPTION OF THE DRAWINGS

In the figures, which illustrate, by way of example only, embodiments of the present invention,

FIG. 1 illustrates the general schematic of the method for detecting biomolecule in a fluid sample in accordance with a first aspect of the present invention.

FIG. 2 illustrates the schematic of the method for detecting a short oligonucleotide from the H5N1 bird flu virus with the sequence 5′-CCA AGC AAC AGA CTC AAA-3′ in accordance with a first embodiment of the present invention.

FIG. 3 shows a typical cyclic voltammogram of the DNA biosensors in the presence of 1 nM complementary DNA (scan rate=0.1 V/sec): first cycle and second cycle in accordance with the first embodiment. The sensor consisted of a 2 mm-diameter Au electrode modified according to the scheme shown in FIG. 1. A typical silver stripping voltammogram is also shown for comparison.

FIG. 4 shows the dependence of the peak current of the anodic Ag/AgCl solid-state process on the concentration of complementary DNA in accordance with the first embodiment. The sensor consisted of a 2 mm-diameter Au electrode; scan rate=0.1 V/sec. Inset shows the voltammetric response of the DNA biosensor to 10 fM of complementary DNA present in the hybridization step.

FIG. 5 shows the voltammetric response of DNA biosensor to 1 pM of (-) complementary DNA and (...) one base-mismatched DNA (sequence: 5′-CCA AGC AAC CGA CTC AAA-3′) in accordance with the first embodiment. Hybridization temperature is about 68° C.

FIG. 6 shows a representation form of the formation of branched disulfide-based polyamidoamine for use in a second embodiment.

FIG. 7 shows the ¹H NMR spectrum of branched disulfide-based polyamidoamine in D₂O, with a representative portion of the polymer's structure of FIG. 6.

FIG. 8 illustrates the schematic of the formation of an electrochemical PSA immunosensor in accordance with the second embodiment.

FIG. 9 shows the cyclic voltammetric response of a PSA immunosensor in the presence of 1.0 and 0 pg/ml of PSA in accordance with the second embodiment. Scan rate is 0.1 V/sec.

FIG. 10 shows the dependence of solid-state Ag oxidation peak currents on PSA concentration in accordance with the second embodiment.

FIG. 11 shows a representation form of the formation of pentaethylenehexamine-based dimer 2 for use in a third embodiment.

FIG. 12 shows the cyclic voltammetric response of a PSA immunosensor in the presence of 0.001 and 0 pg/ml of PSA in accordance with the third embodiment. Scan rate is 0.1 V/sec.

FIG. 13 shows the cyclic voltammetric response of a PSA immunosensor in the presence of 0.001 and 0 pg/ml of PSA in accordance with the third embodiment, except with a non-perfect monolayer. Scan rate is 0.1 V/sec.

FIG. 14 shows the dependence of solid-state Ag oxidation peak currents on PSA concentration in accordance with the third embodiment.

FIG. 15 shows TEM images of Ag nanoparticles (a) before and (b) after conjugation with doxorubicin for use in a third embodiment. Scale bar is 20 nm.

FIG. 16 illustrates the schematic of the formation of an electrochemical DNA biosensor in accordance with the third embodiment.

FIG. 17 shows the voltammetric response of the DNA biosensor in 0.3 M of KCl after hybridization with 1 nM of target DNA in accordance with the third embodiment.

FIG. 18 shows the effect of KCl concentration on the (a) peak current normalized by peak height obtained with 0.08 M of KCl and (b) peak width at half height in accordance with the third embodiment.

FIG. 19 shows the comparison of voltammetric results measured in 0.3 M of KCl when a doxorubicin loading per Ag nanoparticle of (i) about 17 and (ii) about 1 was used in the labeling process in accordance with the third embodiment. Electrodes with the optimal probe density were incubated in 50 μl of 10 nM of the target DNA for hybridization before labeling.

FIG. 20 shows the calibration curve of the DNA biosensor obtained under optimal conditions in accordance with the third embodiment. The error bars indicate one standard deviation from the average of the current peak for each concentration.

### DETAILED DESCRIPTION

The invention relates to a method for detecting biomolecules, such as DNA and protein tumor markers, in a sample, and in particular, to an electrochemical method therefor. The method is suitable for use in diagnostic kits for DNA and protein tumor markers.

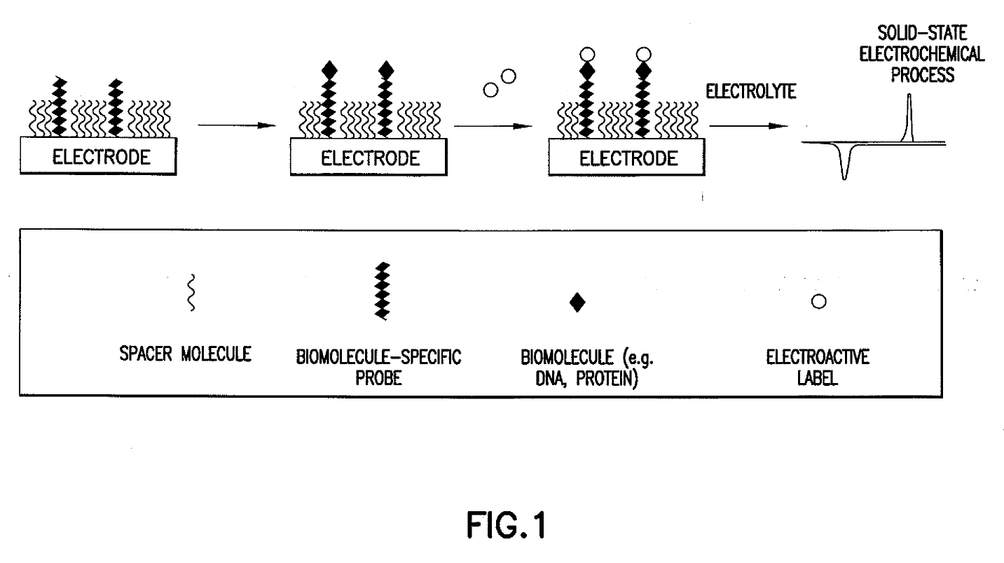

In accordance with a first aspect of the invention, there is provided a method for detecting the presence of a target biomolecule in a sample as illustrated in FIG. 1. Biomolecule-specific probe is first immobilized or assembled on a surface of an electrode to form a modified electrode. Preferably spacer molecules are also immobilized on the electrode. The modified electrode is then exposed to the target biomolecule to be detected. The target biomolecule is captured by the biomolecule-specific probe whereby the biomolecule-specific probe forms a first complex with the target biomolecule present in the sample. Subsequently, the captured target biomolecule is exposed to electroactive label having a binding affinity to the captured target biomolecule. The captured biomolecule adsorbs the electroactive label to the modified electrode to form a working electrode whereby a second complex comprising the first complex with the target biomolecule and the bound electroactive label is formed. The working electrode is next placed in an electrolyte medium and electrochemical measurement between the working electrode and a reference electrode is taken wherein the electrochemical measurement comprises the measurement of electrical signal resulting from a solid-state electrochemical process involving the electroactive labels. The magnitude of the electrochemical measurement corresponds to the concentration of the target biomolecule present in the sample.

Biomolecule-specific probe may include peptide nucleic acid (PNA), which is an analogue of DNA. While DNA contains negatively-charged phosphate backbone, the backbone of PNA is neutral. Consequently, the binding strength between PNA/DNA strands is stronger than that between DNA/DNA strands due to the absence of electrostatic repulsion. Another advantage of utilizing neutral PNA probes instead of negatively-charged DNA probes is the comparatively reduced background signal resulting from the use of neutral PNA probes. A DNA biosensor with DNA probe would produce a large signal even in the absence of target DNA. This large signal is attributed to the binding of positively-charged electroactive labels to the negatively charged single-stranded DNA probes. On the other hand, the biomolecule-specific probe may be DNA-based. In this case, as there exists an electrostatic repulsion between the DNA probe and the target DNA, chemical reagents known as intercalators may be used. The intercalators can bind strongly to the double-stranded DNA through intercalation. Doxorubicin is one of the many intercalators that is suitable for use in this case. Further biomolecule-specific probes may include antibody suitable for capturing the target antigen. Other biomolecule-specific probes and target biomolecules apparent to a person skilled in the art are also included.

The electroactive labels may include metals, metallic compounds, quantum dots and the conjugated-counterparts thereof. Preferably, the electroactive labels are nanosized. More preferably, the electroactive labels are between 3-5 nm in diameter. Preferably, the electroactive labels are silver-based. More preferably, the electroactive labels are metallic silver nanoparticles, doxorubicin-conjugated silver nanoparticles or antibody-conjugated silver nanoparticles.

Advantageously, the solid-state electrochemical process is the Ag/AgCl redox process and the reference electrode is Ag/AgCl. Preferably, the electrochemical measurement is cyclic voltammetric measurement. Solid-state voltammetry includes the voltammetric techniques for investigating the electrochemistry of surface-confined electroactive micro/nano-crystals in contact with an electrolyte medium. Conveniently, the electrolyte medium is KCl. Aqueous KCl electrolyte medium essentially provides a common ion in both solid and liquid phase, hence obtaining a solid-state Ag/AgCl redox process with minimal influence from the dissolution process.

The processes occurring at voltammetric timescale are summarized by Equations (1) and (2):

Ag Nanoparticle (solid)+Cl⁻ (solution)→AgCl (solid)+e⁻ (1)

AgCl (solid)+e⁻ [symbol] Ag (solid)+Cl⁻ (solution) (2)

The magnitude of the peak currents of both solid-state processes depended on the biomolecule such as DNA concentration, and therefore could be used for DNA sensing. However, process represented by Equation (1) occurs at a much more positive potential and at a much slower rate. It would be less suitable for DNA quantification. In contrast, process represented by Equation (2) is well-defined. The peak width at half height is typically about 10 mV, which is much narrower than that of any other existing known voltammetric processes since nucleation and growth process is the rate-limiting step. The anodic peak current is higher; the peak potential is well-separated from oxygen reduction potential and is appropriate for DNA detection.

Stripping voltammetry represents the signal measurement from the electrochemical process converting surface-confined solid or amalgam into solution phase ions. In contrast, solid-state voltammetry involves the measurement of the signal resulting from the conversion between one surface-confined solid to another surface-confined solid.

The solid-state Ag/AgCl process is advantageous because it is simple and highly characteristic. The solid-state Ag/AgCl process described herein possesses distinct voltammetric features that are different from those in the background processes. This is in stark contrast to the other types of electrochemical processes whereby a small signal may not be easily differentiated from the background. The detection of Ag nanoparticles using the solid-state Ag/AgCl process is also anticipated to have higher sensitivity as compared to the conventional stripping voltammetric methods. This is attributed to the very narrow peak associated with the Ag/AgCl process. The area underneath this peak is proportional to the charge consumed. For a given amount of electroactive species involved, the solid-state electrochemical process is expected to have a much higher peak current as compared to the other types of processes.

### EXAMPLES

### Example 1

### DNA Detection Utilizing Neutral PNA (Peptide Nucleic Acid) as Probes and Amine-Functionalized Positively-Charged Ag Nanoparticles as Electroactive Label

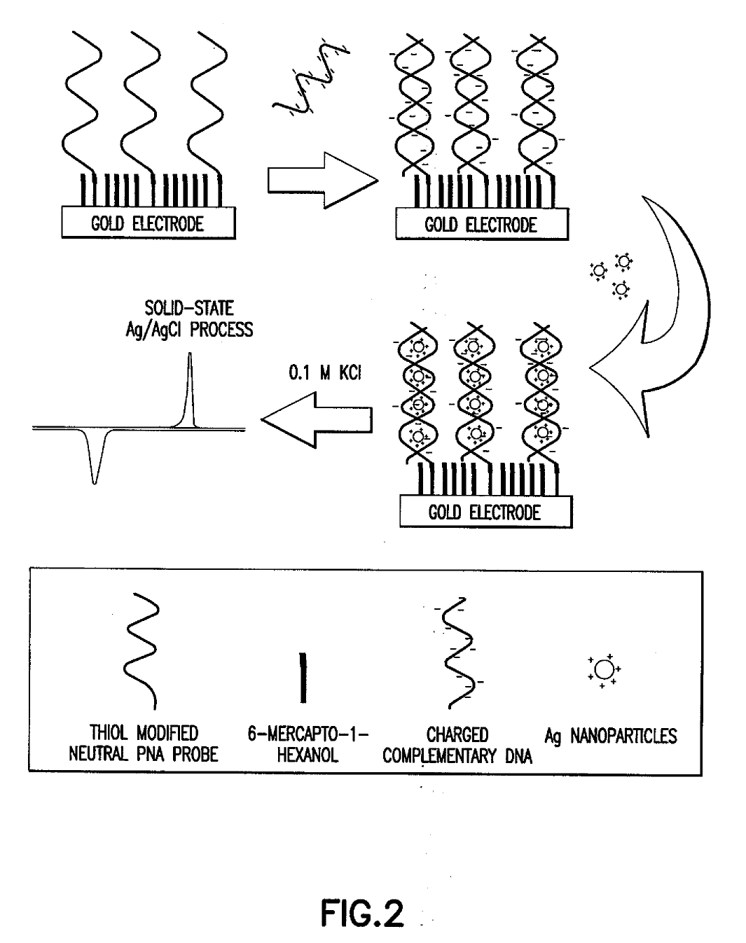

In this first embodiment, neutral PNA were utilized as probes and amine-functionalized positively-charged Ag nanoparticles as an electroactive label that can be detected through a highly characteristic solid-state Ag/AgCl reaction (see FIG. 2). The application of this sensing method was successfully demonstrated with the detection of a short oligonucleotide from the H5N1 bird flu virus with the sequence 5′-CCA AGC AAC AGA CTC AAA-3′ (target biomolecule). A detection limit as low as 10 fM has been achieved.

### Reagents

A short oligonucleotide from the H5N1 bird flu virus with the sequence 5′-CCA AGC AAC AGA CTC AAA-3′ was employed as the target biomolecule (Pipper et al, Nat. Med. 2007, 13, 1259-1263). The biomolecule-specific probes were cysteine-conjugated neutral PNA (with 2-aminoethoxy-2-ethoxy acetic acid as a linker) with a sequence complementary to that of the oligonucleotide from the H5N1 bird flu virus. The electroactive labels were Ag nanoparticles with a typical diameter of 3-5 nm. Monodispersed dodecylamine-capped Ag nanoparticles were firstly synthesized in a toluene solution. To obtain positively charged water-soluble Ag nanoparticles, a reverse micelle-mediated polymerization method (PCT Publication No. WO2009025623A1) was used to introduce a polymer coating of N-(3-aminopropyl) methacrylamide hydrochloride to the nanoparticle surface with persulfate as an oxidant. The resulting particle is highly stable in the pH range of 4-7.5, and positively charged (as indicated by the zeta potential measurements).

### Experimental Procedure

Au electrodes were polished by alumina powder for 5 min and sonicated for 5 min before electrochemical cleaning in an aqueous 0.5 M H₂SO₄ solution (via conducting multiple cycles of potential from −0.2 V to 0.8 V vs. a Pt quasi-reference electrode). PNA probes were assembled onto the clean Au electrodes through Au/thiol chemistry by a two-step process (Herne et al, J. Am. Chem. Soc. 1997, 119, 8916-8920). In brief, the Au electrode was immersed in an aqueous solution containing 2 μM of PNA probes, and then in an aqueous solution containing 2 μM of PNA and 1 mM of 6-mercapto-1-hexanol spacer to obtain a mixed monolayer with an optimal probe density and spatial arrangement to ensure high hybridization efficiency. When the modified electrode was placed in a solution containing the target oligonucleotide, hybridization occurred and a negatively charged surface was formed. This negatively charged surface would adsorb the positively-charged Ag nanoparticles when it was placed in contact with the Ag nanoparticles solution. The electrode was then placed in a 0.1 M KCl solution for the electrochemical measurement. Cyclic voltammetric measurements were conducted from −0.2 V to 0.7 V versus a Ag/AgCl (3M KCl) reference electrode.

### Results and Discussion

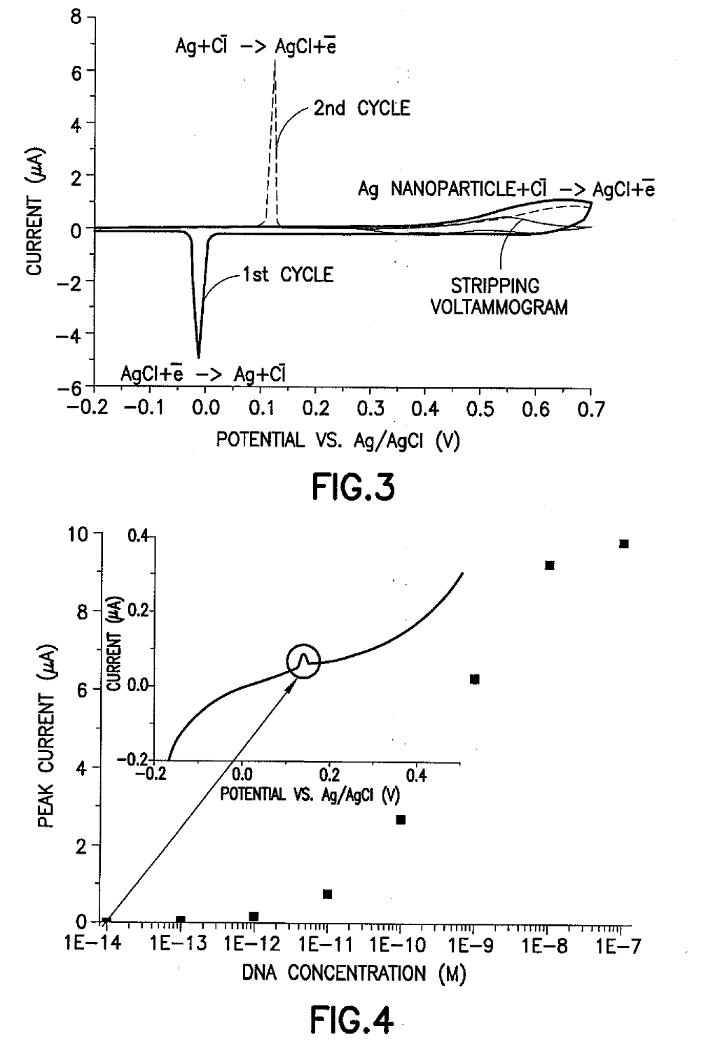

FIG. 3 shows a typical cyclic voltammogram of the DNA biosensors in the presence of 1 nM complementary DNA (scan rate=0.1 V/sec). In the anodic potential sweep, a very sluggish process was observed in the potential range of 0.4-0.7 V vs. Ag/AgCl, corresponding to the oxidation of Ag nanoparticles. The electrogenerated Ag⁺ was precipitated onto the electrode surface in the presence of Cl⁻. Cl⁻ ions from the solution phase were then taken up to form insoluble AgCl in order to maintain charge neutrality in the solid phase. In the reverse cathodic potential cycle, AgCl was reduced to Ag, and Cl⁻ was released into the solution. In a subsequent repetitive potential cycle, Ag was re-oxidized to AgCl, which was re-reduced to Ag.

The magnitude of the peak currents of both solid-state processes depended on the DNA concentration, and therefore could be used for DNA sensing. However, the process represented by Equation (1) occurred at a much more positive potential and at a much slower rate. It would be less suitable for DNA quantification. In contrast, the process represented by Equation (2) was well-defined. Two well-separated sharp current peaks were observed at 0.122 V and −0.012 V vs. Ag/AgCl, respectively. The peak width at half height was about 10 mV, which was much narrower than that of existing known voltammetric processes since nucleation and growth process was the rate-limiting step. The anodic peak current was higher; the peak potential was well-separated from oxygen reduction potential and was appropriate for DNA detection.

To clearly demonstrate the advantage of solid-state voltammetry, the results obtained using the conventional stripping voltammetry has been included in FIG. 3 for comparison. Since the Ag nanoparticles were strongly protected by the capping reagent, a clear stripping voltammogram of the Ag nanoparticles was not obtainable within the potential window in the 0.1 M KNO₃ aqueous electrolyte medium even when the Ag nanoparticles have the maximum coverage on the electrode surface. Instead, bare Ag was electrochemically deposited onto the Au electrode surface from a solution containing 1 mM AgNO₃ and 0.1 M KNO₃, and then stripping voltammetric measurement was conducted in the 0.1 M KNO₃ aqueous electrolyte medium. KNO₃ was used in this case instead of KCl to prevent the formation of solid AgCl, so as to obtain a true stripping voltammogram of Ag. The amount of Ag deposited was controlled so that it was identical to that involved in the solid-state Ag/AgCl process.

It could be clearly seen that solid-state voltammetric response occurred at a much more negative potential whereby a flatter baseline could be obtained and the contribution of background current was usually much smaller. This would be advantageous in real sample analysis where oxidative interferences would be problematic once the potential of measurement became more positive. In contrast, interference from oxygen reduction would typically be present at a more negative potential of measurement. The present method involved measurements in a potential range whereby unwanted oxidative or reductive interferences were minimal. In addition, the solid-state voltammogram has a much sharper and therefore much more intense peak, as compared to the stripping voltammetric response, as expected. Consequently, even when 10 fM of DNA was present, the signal detected was still well-distinguished (see inset of FIG. 4). This level of sensitivity was comparable to those obtained with more complicated existing detection methods (Drummond et al, Nat. Biotech. 2003, 21, 1192-1199; Gooding, Electroanalysis 2002, 14, 1149-1156; Zhang at al, Anal. Chem. 2004, 76, 4093-4097; Wang et al, J. Am. Chem. Soc. 2002, 124, 4208-4209; Patolsky et al, Chem. Eur. J. 2003, 9, 1137-1145; Castañeda at al, Electroanalysis 2007, 19, 743-753).

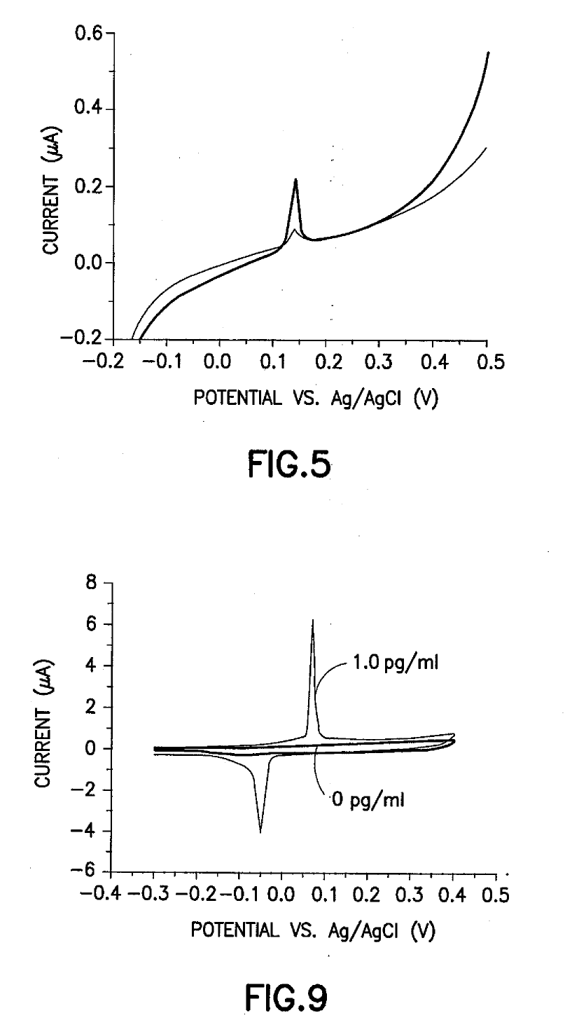

This biosensor also showed a good response to DNA over a wide concentration range (see FIG. 4). The peak current increased when the DNA concentration was increased from 10 fM to 10 nM. The current approached a plateau when the DNA concentration was further increased. At an elevated temperature around the melting temperature of PNA/single mismatched DNA, the DNA biosensor demonstrated a good selectivity towards complementary DNA (see FIG. 5).

By utilizing a highly specific solid-state Ag/AgCl redox process, an ultrasensitive DNA biosensor in a simple yet effective manner has been developed. A low detection limit of 10 fM has been successfully attained, which is among the lowest values reported to date.

### Example 2

### PSA (Prostate-Specific Antigen) Detection Utilizing Ag Nanoparticles as Electroactive Label

PSA is a 33 kDa glycoprotein in the human serum and PSA has been commonly used as a tumor marker for detecting prostate cancer. After successful prostatectomy treatment, PSA levels should be zero. A measurable increase in PSA would be an early sign of relapse. Through the use of ultrasensitive immunosensors in the low pg/ml range, aftercare monitoring and adjuvant therapies could be administered in a timely manner. However, the sensitivities of earlier electrochemical PSA immunosensors are in the sub-ng/ml levels, which are less sensitive. In this second embodiment, an ultrasensitive PSA immunosensor was developed based on a silver enhancement approach followed by the direct detection of the solid-state Ag/AgCl redox process. The measurable signal was greatly amplified and the detection limit achieved was 1 fg/ml.

### Reagents

Prostate-specific antigen (PSA) from human serum (P-3338) was purchased from Sigma-Aldrich. Monoclonal antibodies to PSA were obtained from Meridian Life Science Inc., Biodesign International (M86433M as capture antibody and M86111M as detection antibody). O,O′-bis[2-(N-succinimidyl-succinylamino)ethyl] polyethylene glycol 3,000 (NHS-PEG-NHS), N-(3-dimethylaminopropyl)-N′-ethylcarbodiimide (EDC), N-succinimidyl ester (NHS), 16-mercapto-1-hexadecanoic acid (16-MHA), 11-mercapto-1-undecanol (11-MUOH), sodium borohydride (NaBH₄), silver nitrate (AgNO₃), ascorbic acid, Tween 80 were obtained from Sigma-Aldrich. Reagents for the synthesis of the capping agent, including methyl-3-mercaptopropionate and tris(2-aminoethyl)amine (96%), were also obtained from Sigma-Aldrich. Phosphomolybdic acid sodium salt hydrate (Na₃PMo₁₂O₄₀), which was used as interference agent, was obtained from Sigma-Aldrich.

### Characterization

¹H and ¹³C nuclear magnetic resonance (NMR) spectra were recorded on a Bruker AVANCE 400 at 400 and 100 MHz, respectively, using the indicated deuterated solvents. CS ChemNMR Pro version 6.0 (Upstream Solutions GmbH Scientific Software Engineering CH-6052 Hergiswil, Switzerland) was employed to analyze various protons and carbons.

Infrared (IR) spectra were recorded on a Perkin-Elmer 1600 Fourier-transform infrared (FTIR) spectrometer and a Perkin-Elmer Spectrum One FTIR spectrometer. Samples were prepared with KBr in a disk prior to analysis.

Molecular weight of polyamidoamine was analyzed by gel permeation chromatography (GPC) (Waters 2690, MA, USA) with a differential refractometer detector (Waters 410, MA, USA). The mobile phase consisted of 0.5 M of sodium acetate and 0.5 M of acetic acid solution with a flow rate of 1 mL/min. A Shodex OHpak SB-803 HQ (8.0 mm×300 mm) column was used. Number and weight average molecular weights (Mₙ, and M_{w}) as well as polydispersity indices were calculated from a calibration curve using a series of dextran standards (Aldrich, USA) with molecular weights ranging from 667 to 778000.

The nitrogen content of the polyamidoamine was determined by elemental analysis using Perkin-Elmer Instruments Analyzer 2400 CHN/CHNS and Eurovector EA3000 Elemental Analyzers.

Cyclic voltammetry of the assay was performed with CHI 400 Electrochemical Analyzer (CH Instruments, Texas, USA). Gold electrode (CH Instruments), a platinum wire, and Ag/AgCl (3 M of KCl) electrode (CH Instruments) were used as the working electrode, counter electrode and reference electrode, respectively.

### Electrode Surface Modification

To form a mixed self-assembled monolayer (SAM) on the electrode surface, the Au electrodes were first polished carefully using 0.3-μm alumina slurry, and cleaned electrochemically in a H₂SO₄ solution (0.5 M) by cycling the potential between −0.2 V and 0.8 V vs. Pt wire quasi-reference electrode for 10 min. These electrodes were then washed with deionized (DI) water, and dipped into 100 μl of ethanol solution containing a mixture of 0.1 mM of 16-MHA and 0.9 mM of 11-MUOH overnight.

### Synthesis and Characterization of Branched Disulfide-Based Polyamidoamine (Capping Agent Used for Ag Nanoparticle Synthesis)

### Formation of Branched Disulfide-Based Polyamidoamine

20 ml of methanol, 25 ml of tris(2-aminoethyl)amine (0.17 mol), 38 ml of methyl-3-mercaptopropionate (0.34 mol) and 100 ml of dimethyl sulfoxide (DMSO) were placed in a flask. The flask was left to stir for 3 h at 120° C. Next, the contents of the flask were cooled to 30° C. The crude product was precipitated into tetrahydrofuran (THF), and then dialyzed against water for 1 day with a continuous flow by a membrane dialysis method using dialysis tubing with a molecular weight cut-off (MWCO) of 1 kDa (Spectrum Laboratories, USA). The branched disulfide-based polyamidoamine was harvested by freeze drying, and characterized by IR, and ¹H and ¹³C NMR spectroscopies. Disulfide-based polyamidoamine: uₘₐₓ (KBr disk) (cm⁻¹) 3400 strong (broad) [u(N—H)]; 2950 medium [u(C—H)]; 2360 weak [u(S—H)]; 1640 strong [u(C═O)]. δ_{H} (400 MHz, D₂O) 3.20-3.10 (2H, t, N—CH₂—CH₂—NH—C(═O)—CH₂—CH₂—S—, signal B); 2.90-2.20 (m, —NH—C(═O)—CH₂—CH₂—SH; —NH—C(═O)—CH₂—CH₂—S—S—; NH₂—CH₂—CH₂—N(—CH₂—CH₂—NH—C(═O))₂—, signal A). δ_{C} (100 MHz, D₂O) 175, 54, 52, 38, 37, 35 and 27.

### Analysis of Branched Disulfide-Based Polyamidoamine

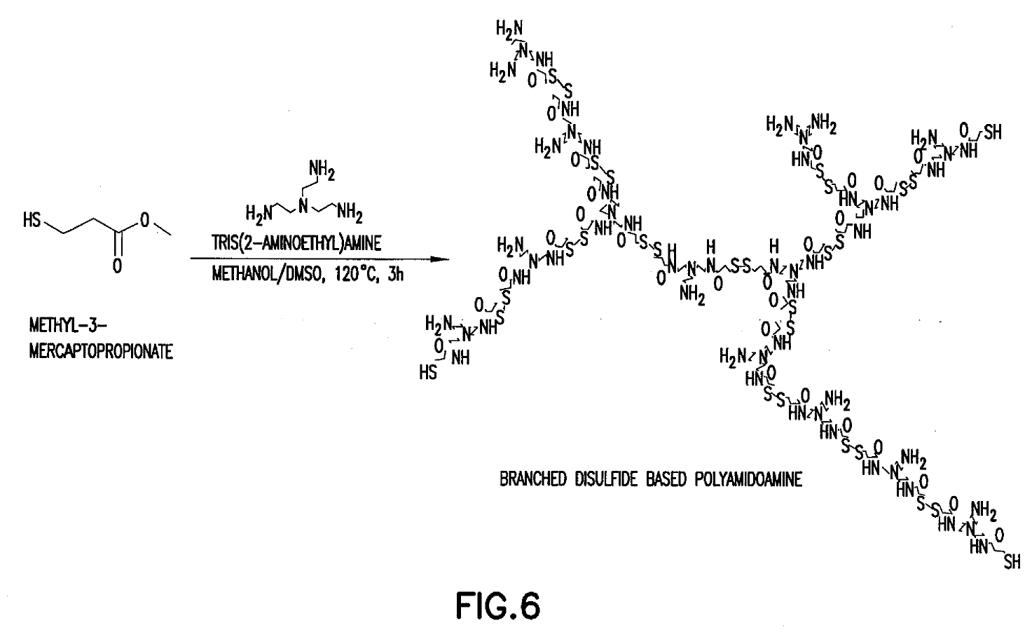

The branched disulfide-based polyamidoamine was prepared in a one-pot reaction via nucleophilic substitution and thiol oxidation between tris(2-aminoethyl)amine and methyl-3-mercaptopropionate as shown in FIG. 6. The reaction was performed in air in DMSO so as to allow the thiol groups to be oxidized rapidly to form the disulfide bonds in the polymer backbone.

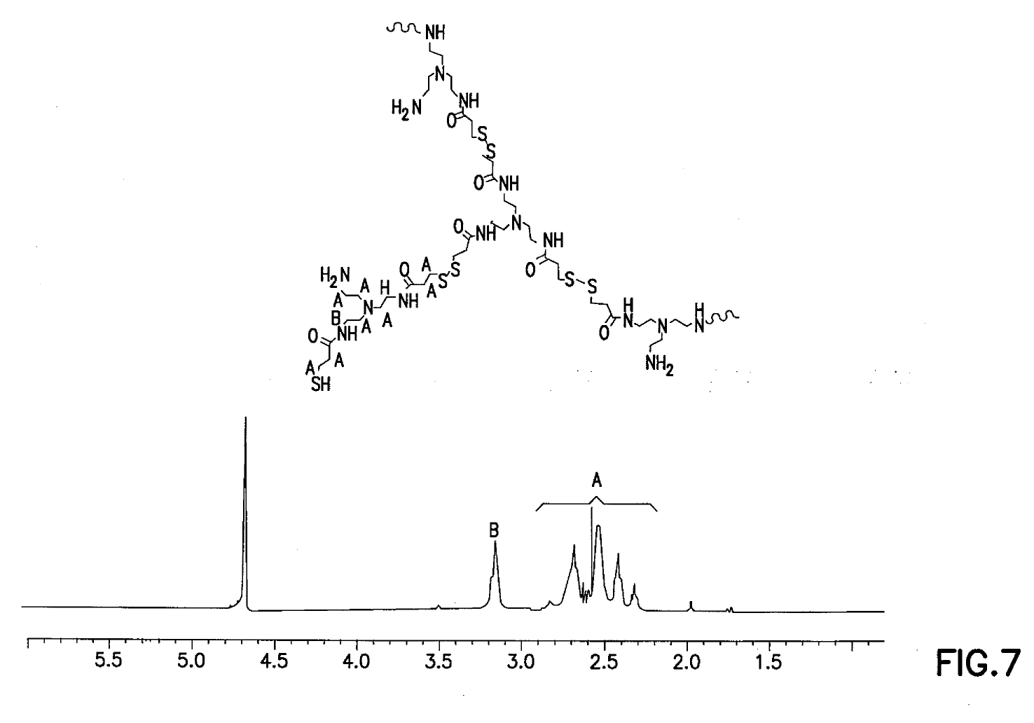

The chemical structure of the disulfide-based polyamidoamine was characterized by ¹H and ¹³C NMR and IR spectroscopies. The ¹H NMR peaks at 2.90-2.20 ppm were assigned to some of the methylene protons (NH₂—CH₂—CH₂—N(—CH₂—CH₂—NH—C(═O))₂—) of tris(2-aminoethyl)amine, as well as the methylene protons (—NH—C(═O)—CH₂—CH₂—S—) from the thiol ester methyl-3-mercaptopropionate (signal A) (see FIG. 7). The peaks at 3.20-3.10 ppm for the remaining methylene protons (NH₂—CH₂—CH₂—N(—CH₂—CH₂—NH—C(═O))₂—, signal B) of the tris(2-aminoethyl)amine moiety demonstrated that the amine group next to these methylene protons was part of a conjugated system, such as that from an amide bond, indicating the successful formation of polyamidoamine. IR spectroscopy further confirmed the structure of polyamidoamine as proposed in FIG. 6. The IR spectrum displayed a strong absorption at 1640 cm⁻¹ assignable to u(C═O) of the amide unit. The expected broad absorption due to the u(N—H) was observed at 3400 cm⁻¹. There was a weak absorption at 2360 cm⁻¹, which was attributed to u(S—H) of the thiol unit. The M_{w} of the branched disulfide-based polymer was determined by GPC to be 4.3 kDa with a polydispersity index of 2.0. The nitrogen content of the polyamidoamine was about 19%, as expected.

### Synthesis and Bioconjugation of Ag Nanoparticles

The water-soluble Ag nanoparticles were synthesized by using the branched disulfide-based polyamidoamine, which contained both thiol group for strong Ag nanoparticle stabilization and primary amine group for further bioconjugation. 1 mM of AgNO₃ and 0.5 mM of branched disulfide-based polyamidoamine (capping agent) were dissolved in 200 ml of DI water and stirred for 10 min. 2 mM of NaBH₄ dissolved in 2 ml of water were added dropwise until the Ag solution turned dark brown. The Ag nanoparticles were then concentrated by evaporating water to 10 ml. The nanoparticles were washed with acetone, precipitated at 21,000 rpm, and re-dissolved in 10 ml of DI water.

To complete the bioconjugation between the Ag nanoparticles and the detection antibodies, NHS-PEG-NHS 3000 was used as the long-arm linker. The two long ends of the NHS-PEG-NHS 3000 binded to amine groups through a well-established chemical reaction. Ag nanoparticles (0.850 mg) were first diluted in 1 ml of borate buffer (pH 7.5) and mixed with NHS-PEG-NHS 3000 (20 mg dissolved in 100 μl of DMSO) to achieve linkage between NHS-PEG-NHS and the Ag nanoparticles. An excess amount of NHS-PEG-NHS was used to prevent aggregation between the Ag nanoparticles. After 15 min of incubation, the NHS-PEG-NHS-conjugated Ag nanoparticles were passed through a Sephadex column to remove excess free NHS-PEG-NHS that was not bound to the Ag nanoparticles. The recovered activated Ag nanoparticles were immediately mixed with M86111M detection antibody (1 ml of 0.2 mg/ml antibody) and incubated for 2 h under shaking. 100 μl of Tris hydroxymethyl (aminomethane) (TRIS) (pH 7.4) buffer were added to block any free NHS groups. The conjugated nanoparticles were kept at 4° C.

### Sandwich Immunoassay

The COOH groups on the surface of the mixed monolayer-modified electrodes were activated with 20 mM of NHS and 100 mM of EDC for 15 min. The electrodes were washed with DI water, and immediately dipped in 100 μg/ml of M86433M capture antibody (antibody was diluted to the desired concentration with 10 mM of acetate buffer (pH 6.0)). After 1 h of incubation, the electrodes were washed with DI water, and immersed for 10 min in 1 M of ethanolamine (pH 8.5) to block any free activated NHS groups. The electrodes were washed with 10 mM of glycine (pH 2.2) to remove any non-covalently bound antibodies.

The electrodes prepared were exposed to PSA analyte at different concentrations from 0-100 ng/ml for 1 h. The electrodes were washed with phosphate buffered saline (PBS) before dipping into the Ag nanoparticle-labeled detection antibody. After 1 h, the electrodes were washed thoroughly with 0.01 M of TRIS buffer (pH 7.4) containing 0.15 M of NaCl to remove non-specifically bound nanoparticles. The electrodes were then vigorously washed with DI water. The Ag nanoparticles were developed in Ag enhancement solution (1 mM of AgNO₃, 0.5 mM of ascorbic acid and 0.5% of Tween 80) for 10 min. The electrodes were then washed again with DI water, and a cyclic voltammetry was applied to read the signal response.

### Experimental Procedure

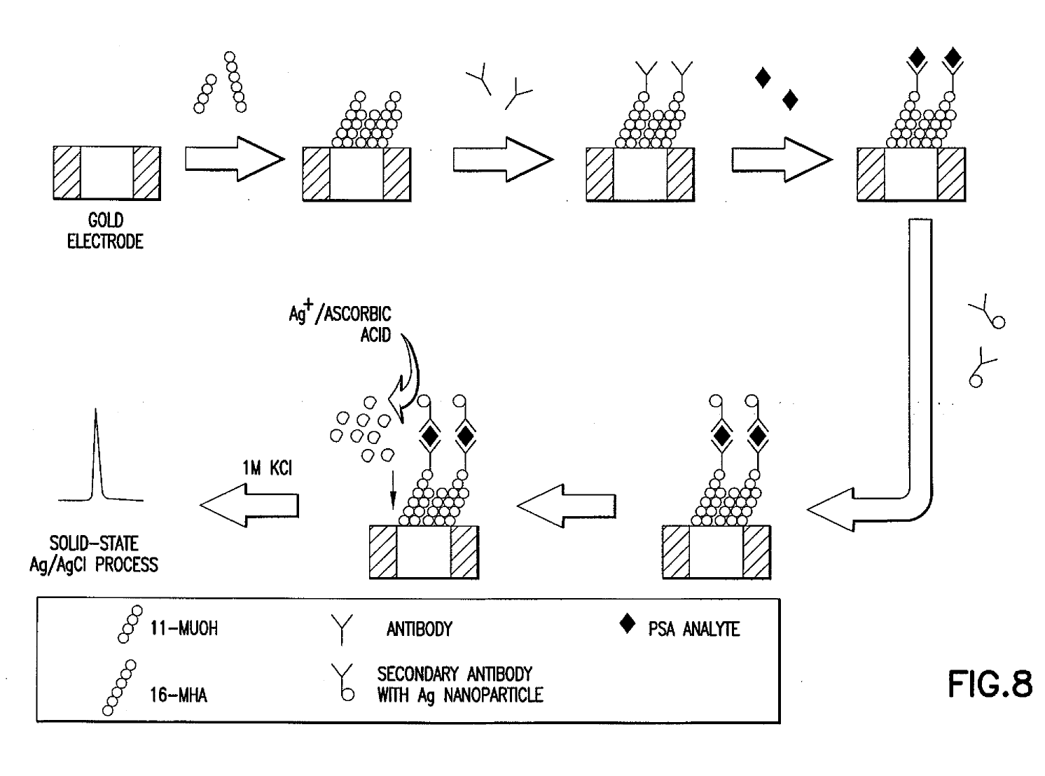

The experimental procedures can be summarized by FIG. 8. A mixture containing 10 mol % 16-mercapto-1-hexadecanoic acid (16-MHA) for antibody immobilization and 90 mol % 11-mercapto-1-undecanol (11-MUOH) spacer was introduced onto the Au electrode surface through the thiol-Au interaction. The ratio of 16-MHA and 11-MUOH was chosen to obtain an optimal density of COOH group for maximizing the antibody immobilization efficiency and minimizing non-specific adsorption. Next, monoclonal PSA capture antibodies were covalently conjugated to 16-MHA through the addition of N-(3-dimethylaminopropyl)-N′-ethylcarbodiimide (EDC) and N-hydroxysuccinimide (NHS), resulting in a coupling reaction between COOH from the 16-MHA and —NH₂ from the antibodies. After PSA was bound to the capture antibody, a second branched disulfide-based polyamidoamine capped Ag nanoparticle-labeled PSA-detection antibody was used to complete the sandwich assay. The final step involved a silver enhancement strategy through a seed-mediated nucleation/growth mechanism (JANA et al, Chem. Mater. 2001, 13, 2313-2322) using a silver developer solution containing 1 mM of AgNO₃, 0.5 mM of ascorbic acid and 0.5% of Tween 80. Silver ion was reduced by ascorbic acid in the presence of Ag nanoparticle seeds from the detection antibodies, forming more Ag nanoparticles, some of which were precipitated on the mixed monolayer modified electrode surface. These newly formed Ag nanoparticles have a good electronic communication with the Au electrode since the thickness of the monolayer was about 1 nm, instead of more than 10 nm from the original seeds governed by the size of the antibody. The electrode was then placed in contact with 1 M of KCl solution for cyclic voltammetric measurements.

### Results and Discussion

The cyclic voltammogram obtained in the presence of 1 pg/ml of PSA is shown in FIG. 9, and compared to that of a blank solution, i.e. 0 pg/ml of PSA (note: control experiments with 10 nM of albumin also showed negligible response). It was notable that the features of the solid-state Ag/AgCl process, both peak width at half height as well as peak potentials, remained unchanged. This suggested that although the presence of a thiol monolayer on the electrode surface was expected to greatly reduce the rate constant of the interfacial electron transfer process, the rate-limiting step of this solid-state process (which was the nucleation/growth process), remained unaltered.

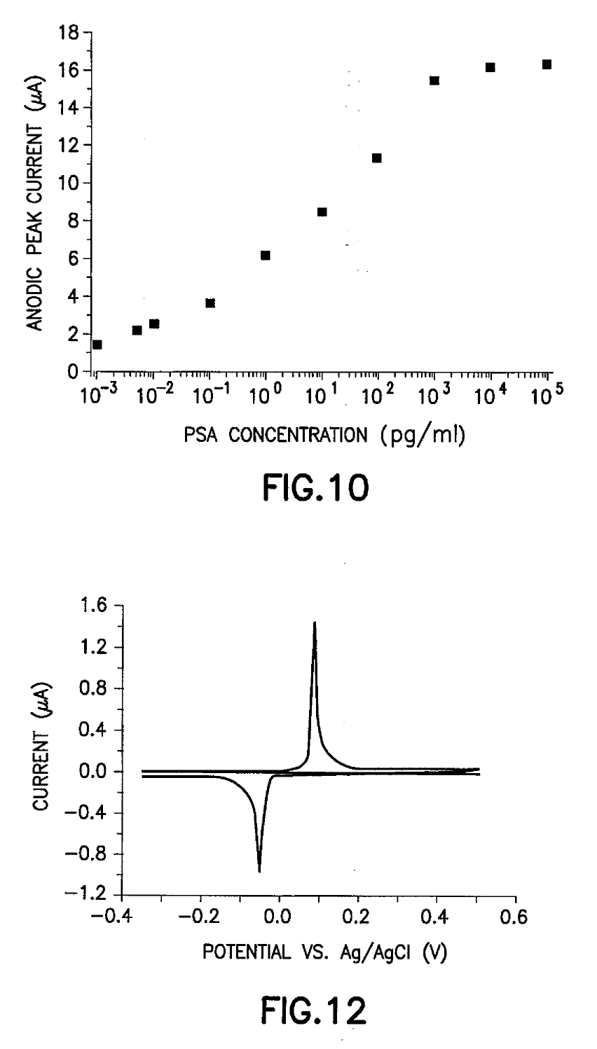

The magnitude of the peak currents depended on the amount of Ag, and thus on the concentration of PSA. This relationship could be used for quantifying PSA detection. This sensor has a good response to PSA over a wide concentration range (see FIG. 10). The solid-state Ag oxidation peak current increased as the PSA concentration was increased from 1 fg/ml to 1 ng/ml. A plateau was reached when the PSA concentration was higher than 1 ng/ml. Standard deviation associated with the measurements of 1 pg/ml PSA was typically ±20% for six parallel experiments. The curve in FIG. 10 deviated from a sigmoidal shape, which would be expected if a simple Langmuir isotherm was applicable to the surface binding process. Langmuir isotherm assumes that every individual binding process is the same and unaffected by the neighboring species, which may be a good approximation when the labeling species are small molecules instead of the nanoparticles used in this experiment. The curve might have also deviated from a sigmoidal shape when the silver enhancement step was introduced, since the rate of mass transport, and hence the rate of silver deposition, would decrease as the density of Ag nanoparticle sites increased.

By combining silver enhancement mechanism and a highly specific solid-state Ag/AgCl redox process, an ultrasensitive sandwich PSA immunosensor has been developed. This simple yet effective approach has attained a detection limit that is comparable to the most sensitive methods reported. With its high sensitivity and good reproducibility, this method may be broadly applied to other protein sensing clinical applications.

### Example 3

### PSA (Prostate-Specific Antigen) Detection Utilizing Ag Nanoparticles as Electroactive Label

In this third embodiment, an ultrasensitive PSA immunosensor was developed based on a silver enhancement approach followed by the direct detection of the solid-state Ag/AgCl redox process. The experimental procedure is similar to that of Example 2, except that the measurable signal was now greatly amplified and the detection limit achieved was 0.1 fg/ml.

### Reagents

Prostate-specific antigen (PSA) from human serum (P-3338) was purchased from Sigma-Aldrich. Monoclonal antibodies to PSA were obtained from Meridian Life Science Inc., Biodesign International (M86433M as capture antibody and M86111M as detection antibody). O,O′-bis[2-(N-succinimidyl-succinylamino)ethyl] polyethylene glycol 3,000 (NHS-PEG-NHS), N-(3-dimethylaminopropyl)-N′-ethylcarbodiimide (EDC), N-succinimidyl ester (NHS), 16-mercapto-1-hexadecanoic acid (16-MHA), 11-mercapto-1-undecanol (11-MUOH), sodium borohydride (NaBH₄), silver nitrate (AgNO₃), ascorbic acid, Tween 80, pentaethylenehexamine (technical grade), methyl-3-mercaptopropionate, epichlorohydrin and tris(2-aminoethyl)amine (96%) were obtained from Sigma-Aldrich.

### Instruments

Cyclic voltammetry of the assay was performed with CHI 400 Electrochemical Analyzer (CH Instruments, Texas, USA). Gold electrode (CH Instruments), a platinum wire, and Ag/AgCl (3 M of KCl) electrode (CH Instruments) were used as the working electrode, counter electrode and reference electrode, respectively.

### Electrode Surface Modification

To form a mixed self-assembled monolayer (SAM) on the electrode surface, the Au electrodes were first polished carefully using 0.3-μm alumina slurry, and cleaned electrochemically in a H₂SO₄ solution (0.5 M) by cycling the potential between −0.2 V and 0.8 V vs. Pt wire quasi-reference electrode for 5 min. These electrodes were then washed with deionized (DI) water, and dipped into 100 μl of ethanol solution containing a mixture of 0.1 mM of 16-MHA and 0.9 mM of 11-MUOH overnight.

### Synthesis and Characterization of Pentaethylenehexamine-Based Dimer 2 (Capping Agent)

### Formation of Tri-Star Amine Monomer 1

10 ml of tris(2-aminoethyl)amine (0.067 mol), 50 ml of methanol, 18 ml of epichlorohydrin (0.23 mol) were introduced to a flask. The mixture was left to stir in an ice bath for 24 h. Next, 100 ml of pentaethylenehexamine (0.34 mol) and 30 ml of triethylamine (0.22 mol) were added to the contents of the flask. The mixture was left to stir at 120° C. for 24 h. The contents of the flask were then dialyzed against water (under continuous flow) using dialysis tubing with a molecular weight cut-off (MWCO) of 500 Da (Spectrum Laboratories, USA) for 1 day, followed by freeze drying. δ_{H} (400 MHz, D₂O): 3.70-3.60 (1H, m, —CH₂—CH(OH)CH₂—), 2.80-2.30 (m, —NH—CH₂—CH₂—NH—, —CH₂—CH(OH)CH₂, NH₂—CH₂—CH₂—NH—, —NH—CH₂—CH₂—N(—CH₂—CH₂—NH—)₂). δ_{C} (100 MHz, D₂O): 68, 56, 53, 52, 48, 47, 46, 45, 44, 39, 38 and 37.

### Formation of Pentaethylenehexamine-Based Dimer 2

6.5 g of the dry tri-star amine (0.0064 mol) was added to a flask containing 50 ml of dimethyl sulfoxide and 50 ml of methanol. Next, 0.70 ml of methyl-3-mercaptopropionate (0.0064 mol) was added to this flask. The mixture was left to stir at 80° C. for 18 h. It was then dialyzed against water (under continuous flow) using dialysis tubing with a molecular weight cut-off (MWCO) of 500 Da (Spectrum Laboratories, USA) for 1 day, followed by freeze drying. δ_{H} (400 MHz, D₂O): 3.70-3.60 (1H, m, —CH₂—CH(OH)CH₂—), 3.40-3.30 (2H, t, —NH—CH₂—CH₂—NH—C(═O)—CH₂—CH₂—S—), 2.80-2.30 (m, —NH—CH₂—CH₂—NH—, —NH—CH₂—CH₂—NH—C(═O)—CH₂—CH₂—S, —CH₂—CH(OH)CH₂—, NH₂—CH₂—CH₂—NH— and —NH—CH₂—CH₂—N(—CH₂—CH₂—NH—)₂). δ_{C} (100 MHz, D₂O): 67, 58, 56, 55, 54, 52, 49, 48, 47, 45, 44, 39, 38 and 37.

### Synthesis and Characterization of Pentaethylenehexamine-Based Dimer 2

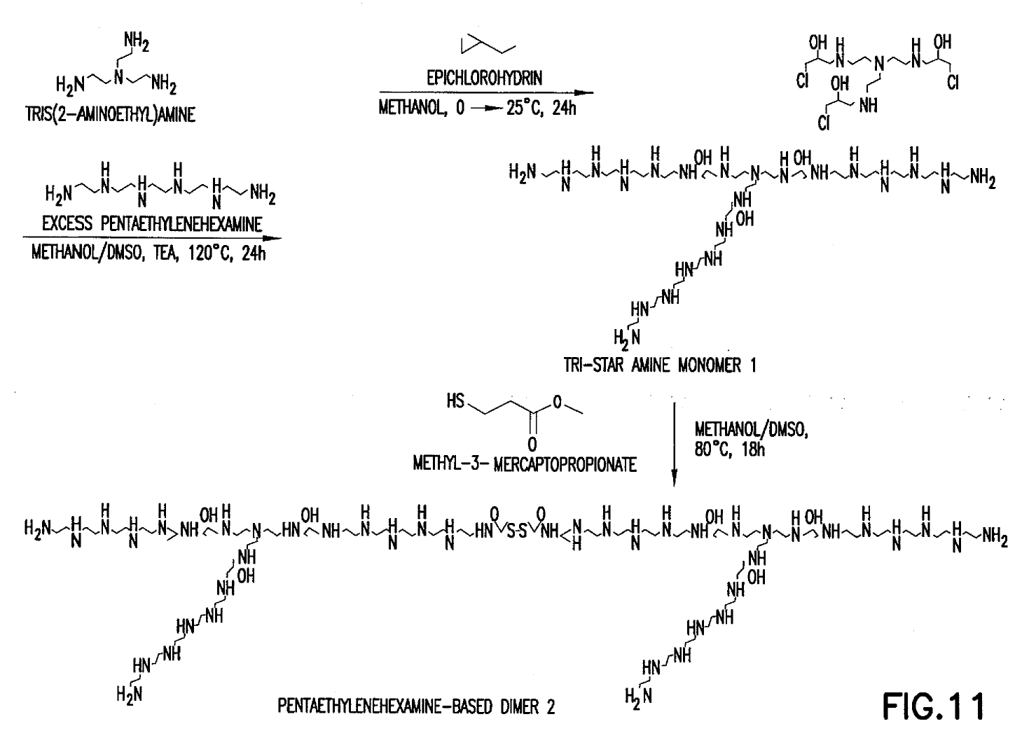

A polyamine dimer via a two-step procedure that involved a ring-opening mechanism in conjunction with nucleophilic substitution was prepared. For this simple procedure employed, pentaethylenehexamine was used as the main amine (see FIG. 11). In brief, the tri-star amine monomer 1 compound was initially formed by reacting the core amine, tris(2-aminoethylene)amine with epichlorohydrin in methanol via ring-opening in an ice bath for 24 h, and then reacted this core amine with pentaethylenehexamine via nucleophilic substitution in an oil bath at 120° C. for 24 h. Next, tri-star amine monomer compound was purified via dialysis in water. The tri-star amine monomer was then reacted with thiol ester, methyl-3-mercaptopropionate via nucleophilic substitution at 80° C. for 24 h. The pentaethylenehexamine-based product dimer 2 was obtained via dialysis of the reaction mixture in running water for a period of 1 day. The structure of dimer 2 was confirmed via ¹H and ¹³C NMR spectroscopy.

### Synthesis and Bioconjugation of Ag Nanoparticles

1 mM of AgNO₃ and 0.5 mM of polymer were dissolved in 200 ml of DI water and stirred for 10 min. 2 mM of NaBH₄ dissolved in 2 ml of water were added dropwise until the Ag solution turned dark brown. The Ag nanoparticles were then concentrated by evaporating water to 10 ml. The nanoparticles were washed with acetone, precipitated at 21,000 rpm, and re-dissolved in 10 ml of DI water.

0.850 mg of Ag nanoparticles were diluted in 1 ml of borate buffer (pH 7.5) and mixed with NHS-PEG-NHS 3000 (20 mg dissolved in 100 μl of DMSO). After 15 min of incubation, the NHS-PEG-NHS conjugated nanoparticles were passed through a Sephadex Column to remove excess NHS-PEG-NHS. The recovered activated particles were immediately mixed with M86111M detection antibody (1 ml of 0.2 mg/ml antibody) and incubated for 2 h under shaking. 100 μl of TRIS buffer was added to block any free NHS groups. The conjugated nanoparticles were preserved at 4° C.

### Sandwich Immunoassay

The COOH groups on the surface of the mixed monolayer-modified electrodes were activated with 20 mM of NHS and 100 mM of EDC for 15 min. The electrodes were washed with DI water, and immediately dipped in 100 pg/ml of M86433M capture antibody (antibody was diluted to the desired concentration with 10 mM of acetate buffer (pH 6.0)). After 1 h of incubation, the electrodes were washed with DI water, and immersed for 10 min in 1 M of ethanolamine (pH 8.5) to block any free activated NHS groups. The electrodes were washed with 10 mM of glycine (pH 2.2) to remove any non-covalently bound antibodies.

The electrodes prepared were exposed to PSA analyte at different concentrations from 0 pg/ml to 1000 pg/ml for 1 h. The electrodes were washed with phosphate buffered saline (PBS) before dipping into the Ag nanoparticle-labeled detection antibody. After 1 h, the electrodes were washed thoroughly with 0.01 M of TRIS buffer (pH 7.5) with 0.15 mM of NaCl to remove non-specifically bound nanoparticles. The electrodes were then vigorously washed with DI water. The Ag nanoparticles were developed in Ag enhancement solution (1 mM of AgNO₃, 0.5 mM of ascorbic acid and 0.5% of Tween 80) for 10 min. The electrodes were then washed again with DI water, and a cyclic voltammetry was applied to read the signal response.

### Experimental Procedure

The experimental procedures can be summarized by FIG. 8. A mixture containing 10 mol % 16-mercapto-1-hexadecanoic acid (16-MHA) for antibody immobilization and 90 mol % 11-mercapto-1-undecanol (11-MUOH) spacer was introduced onto the Au electrode surface through the thiol-Au interaction. The ratio of 16-MHA and 11-MUOH was chosen to obtain an optimal density of COOH group for maximizing the antibody immobilization efficiency and minimizing non-specific adsorption. Next, monoclonal PSA capture antibodies were covalently conjugated to 16-MHA through the addition of N-(3-dimethylaminopropyl)-N′-ethylcarbodiimide (EDC) and N-hydroxysuccinimide (NHS), resulting in a coupling reaction between COOH from the 16-MHA and —NH₂ from the antibodies. After PSA was bound to the capture antibody, a second Ag nanoparticle-labeled PSA-detection antibody was used to complete the sandwich assay. The final step involved a silver enhancement strategy through a seed-mediated nucleation/growth mechanism using a silver developer solution containing 1 mM of AgNO₃, 0.5 mM of ascorbic acid and 0.5% of Tween 80. Silver ion was reduced by ascorbic acid in the presence of Ag nanoparticle seeds from the detection antibodies, forming more Ag nanoparticles, some of which were precipitated on the mixed monolayer modified electrode surface. These newly formed Ag nanoparticles have a good electronic communication with the Au electrode since the thickness of the monolayer was about 1 nm, instead of more than 10 nm from the original seeds governed by the size of the antibody. The electrode was then placed in contact with 1 M of KCl solution for cyclic voltammetric measurements.

### Results and Discussion

The cyclic voltammogram obtained in the presence of 1 fg/ml (i.e. 0.001 pg/ml) of PSA is shown in FIG. 12, and compared to that of a blank solution, i.e. 0 pg/ml of PSA. In the forward anodic potential sweep, Ag was oxidized to Ag⁺ which was then precipitated onto the electrode surface in the presence of Cl⁻. The peak potential for this process was 0.079±0.005 V vs. Ag/AgCl electrode (3 M of KCl). In the reverse cathodic potential sweep, the solid AgCl on the electrode surface was reduced to Ag, and Cl⁻ was released into the solution. Peak potential for this process was −0.057±0.005 V vs. Ag/AgCl electrode (3 M of KCl).

The magnitude of the peak current of the forward potential sweep depended on the amount of Ag, and thus on the concentration of PSA. This relationship could be used for quantifying PSA detection. The solid-state voltammetric process is advantageous in providing a highly characteristic process for analytical applications. Unlike other types of electrochemical processes whereby the signal is hardly distinguishable from the background once it becomes too small, the voltammetric characteristics of the solid-state process employed herein are distinctly different from those of the possible background processes. This approach also offers high sensitivity due to the extremely narrow peak (peak width at half height is typically about 10 mV) associated with the Ag/AgCl solid-state process. The width of this peak depends on the concentration of KCl. The peak is narrowest when 1 M KCl was used as the electrolyte. The area underneath this peak is proportional to the charge consumed. Therefore a much larger current can be detected in the solid-state electrochemical process compared to other types of processes when an equal amount of electroactive labels is consumed. Consequently, the signal due to the presence of 1 fg/ml of PSA is clearly distinguishable from the background signal.

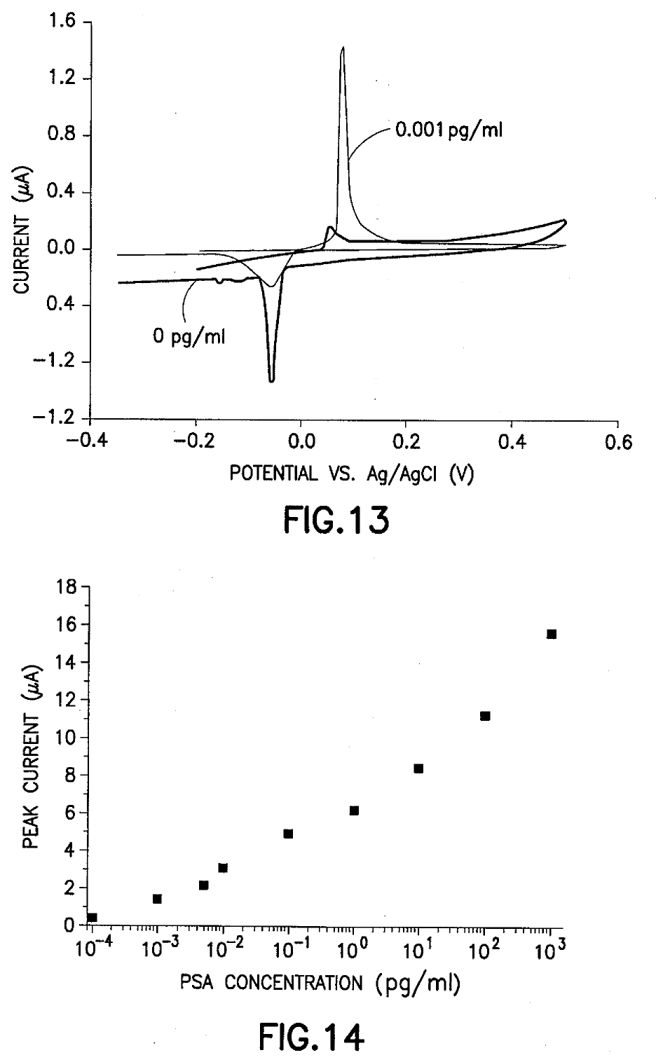

In order to obtain a clean background, it is important to minimize the non-specific adsorption of the conjugated detection antibody. This non-specific adsorption was minimized by washing with 0.01 M of TRIS buffer (pH 7.4) with 0.15 mM NaCl after the sandwich binding event to obtain a clean black signal (see FIG. 12). When a bare Au electrode was dipped into the Ag developer solution, Ag could also directly grow on the electrode surface as indicated by the voltammetic data obtained in 1 M KCl solution, presumably due to the presence of crystal defects. When the mixed monolayer was perfectly assembled on the electrode surface, this direct growth is negligible. However, the mixed monolayer can hardly be always perfect. In this case, the Ag/AgCl process could also be detected from the black solution. The Ag/AgCl signal detected from the blank solution was largely due to this reason. However, since the Ag nanoparticles were directly in contact with the metallic Au electrode surface in such case, the potential at which the signal was observed was less positive (0.057 V instead of 0.079 V vs. Ag/AgCl as shown in FIG. 13) as less driving force was required for the electrochemical oxidation of Ag nanoparticles. As a result, the blank experiment obtained under this situation showed a negligible signal due to the solid-state Ag/AgCl process when PSA was present.

The silver enhancement step is crucial for the development of an ultrasensitive electrochemical PSA sensor based on the direct electrode detection of Ag. In the absence of silver enhancement, this electrochemical response was not readily observed within the same potential window due to the extended distance between the Au electrode and the Ag nanoparticles from the detection antibody (typically more than 10 nm) and hence poor electronic communication between them.

This sensor has a good response to PSA over a wide concentration range (see FIG. 14). The peak current increased when the concentration of the PSA increased from 0.1 fg/ml to 1 ng/ml. A plateau was reached when the PSA concentration was higher than 1 ng/ml. Standard deviation associated with these measurements was typically ±20% for six parallel experiments.

By combining silver enhancement mechanism and a highly specific solid-state Ag/AgCl redox process, an ultrasensitive sandwich PSA immunosensor has been developed. This simple yet effective approach has attained a detection limit that is comparable to the most sensitive methods reported. This method can be easily incorporated into a flow injection system or micro-electro-mechanical system (MEMS). With its high sensitivity and good reproducibility, this method may be broadly applied to other protein sensing clinical applications.

### Example 4

### DNA Detection Utilizing Doxorubicin-Conjugated Ag Nanoparticles as Electroactive Label

### Reagents

3′ thiolated oligonucleotide probe (sequence: 5′-TTT GAG TCT GTT GCT TGG AAA AAA-3′), target oligonucleotide (sequence: 5′-CCA AGC AAC AGA CTC AAA-3′), 1 M of tris(hydroxymethyl)aminomethane (TRIS) buffer (pH 7.0), 20× saline sodium citrate (SSC) buffer solution (1×SSC contained 0.15 M of sodium chloride and 0.015 M of sodium citrate), and 10% (w/v) sodium dodecyl sulfate (SDS) solution were obtained from 1st Base Pte. Ltd. O,O′-bis[2-(N-succinimidyl-succinylamino)-ethyl] polyethylene glycol 3,000 (NHS-PEG-NHS), 6-mercapto-1-hexanol (MCH), sodium borohydride (NaBH₄), potassium phosphate monobasic (KH₂PO₄), sodium chloride (NaCl), sodium hydroxide (NaOH), ethylenediaminetetraacetic acid (EDTA), silver nitrate (AgNO₃) and doxorubicin were obtained from Sigma-Aldrich. Reagents used for the synthesis of the polymer capping agent of the Ag nanoparticles including pentaethylenehexamine (technical grade), methyl-3-mercaptopropionate, tris(2-aminoethyl)amine (96%), and epichlorohydrin were obtained from Sigma-Aldrich. PD-10 disposable desalting columns were obtained from GE healthcare. Nanopure water (resistivity more than 18 KΩ·cm) was used.

### Apparatus

Cyclic voltammetry was performed with a CHI 400 electrochemical analyzer (CH instruments, Austin, Tex.). A conventional 3-electrode system was employed. A 2 mm-diameter gold electrode (CH instruments, Austin, Tex.), a platinum wire and a Ag/AgCl (3M KCl) electrode (CH instruments, Texas) were used as the working electrode, counter electrode and reference electrode, respectively. Fluorescence and absorption spectra were obtained with a Fluorolog®-3 spectrofluorometer (Jobin Yvon Inc., New Jersey) and an Agilent 8453 UV-Vis spectrometer, respectively. TEM experiments were performed on a JEOL JEM-3010 electron microscope (200 kV). Centrifugation was done using an Allegra 64R Centrifuge (Beckman Coulter, California).

### Synthesis and Conjugation of Ag Nanoparticles

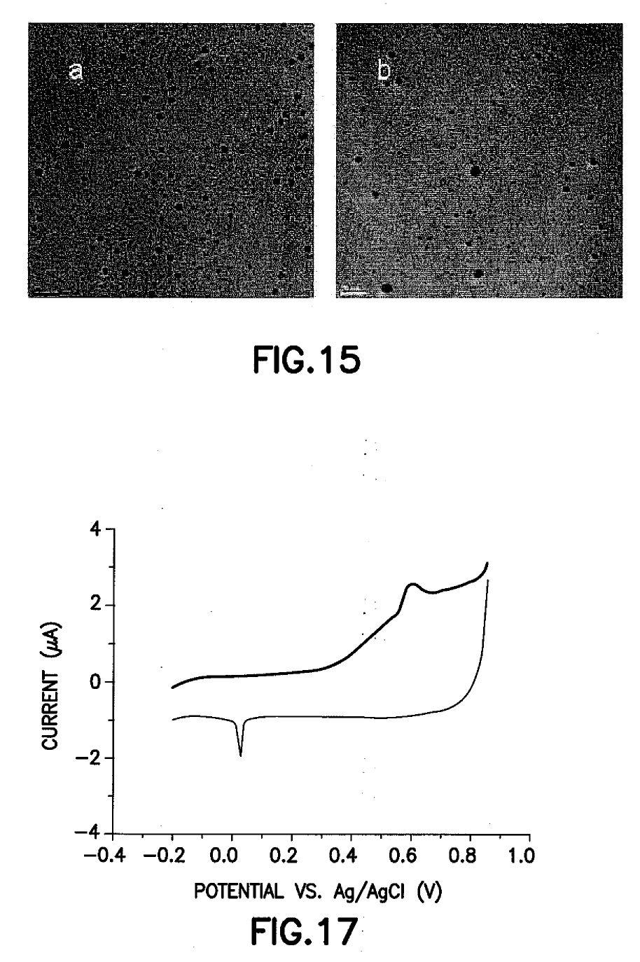

The capping agent used for the synthesis of the Ag nanoparticles was a low molecular weight polymer that contained both disulfide and primary amine (Zhang at al, Small 2009, 5, 1414-1417), The Ag nanoparticles were prepared by the chemical reduction of Ag⁺ ions in the presence of the capping agent. Briefly, 1 mM of AgNO₃ and 0.5 mg/ml of polymer were dissolved in 200 ml of water, and stirred for 10 min. 15 mg of NaBH₄ dissolved in 2 ml of water were added dropwise, resulting in a dark brown solution. The solution was then concentrated to 10 ml through evaporation. The nanoparticles were separated from the reaction mixture by precipitating in a water/acetone mixture and centrifugation at 21,000 rpm. The supernatant was discarded, while the precipitate was re-dissolved in water. This procedure was repeated twice to ensure the high purity of the final product. The synthesized Ag nanoparticles were re-dissolved in 10 ml of water as a stock solution for further application. They displayed an absorption band at 404 nm, which corresponded to the characteristic surface plasma resonance band of Ag nanoparticles. TEM image showed that the Ag nanoparticles were about 5 nm in diameter (FIG. 15a).

The Ag nanoparticles were conjugated with doxorubicin through their primary amines by utilizing the NHS-PEG-NHS bifunctional linker. Firstly, 0.850 mg of Ag nanoparticles was diluted in 1 ml of borate buffer (pH 7.5), and mixed with an excessive amount of NHS-PEG-NHS (10 mg dissolved in 100 μl of dimethyl sulfoxide (DMSO)), so that statistically only one NHS from NHS-PEG-NHS could react with a primary amine on the Ag nanoparticle surface. Cross-linking and aggregation could thus be minimized. This solution was incubated for 5-15 min before the NHS-PEG-NHS-conjugated nanoparticles were passed through the Sephadex column to remove excess NHS-PEG-NHS. Incubation time was varied to control the amount of NHS-PEG-NHS per Ag nanoparticle, so as to manipulate the loading of doxorubicin per Ag nanoparticle. The NHS-PEG-NHS-activated Ag particles were immediately mixed with 1 ml of 5 mM of doxorubicin, and incubated for 2 h under shaking. Next, 100 μl of 1 M of tris(hydroxymethyl) aminomethane (TRIS) buffer (pH 7.0) were added to block any unreacted NHS groups. The conjugated nanoparticles were passed through the Sephadex columns twice to completely remove unbound doxorubicin. The successful conjugation between doxorubicin and Ag nanoparticles was confirmed by the doxorubicin fluorescence at about 590 nm exhibited by the conjugated Ag nanoparticle solution. The fluorescence peak of doxorubicin was also used to quantify the doxorubicin loading on the Ag nanoparticles. TEM image showed that the Ag nanoparticles remained unchanged in size after conjugation (FIG. 15b). The doxorubicin-conjugated Ag nanoparticles were stored in the dark at 4° C.

### Experimental Procedure

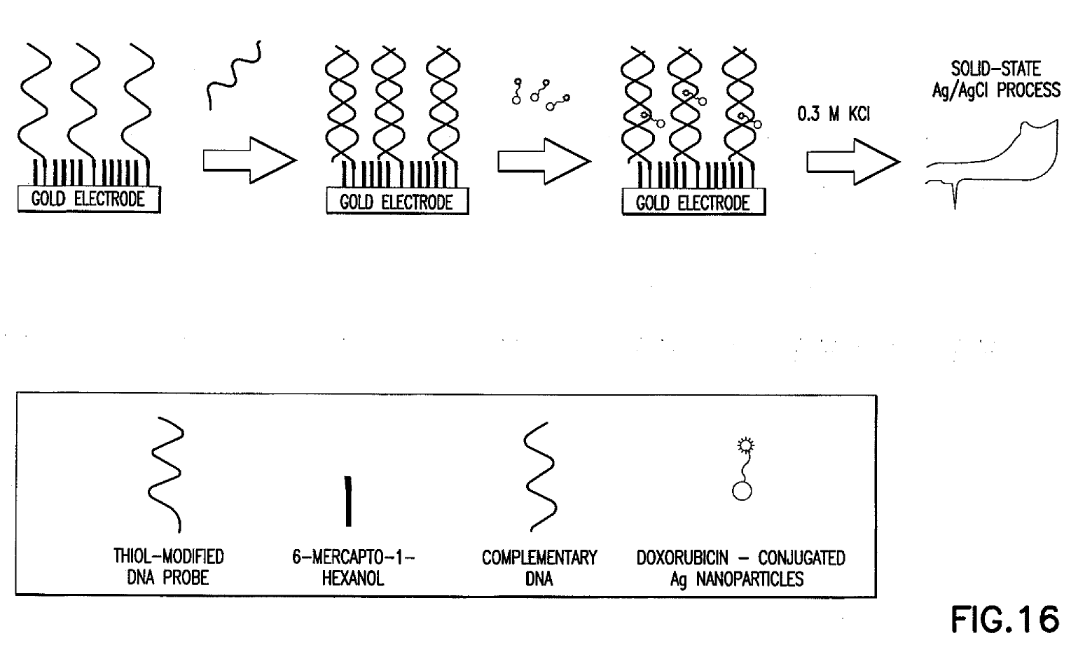

The gold electrode modification and DNA hybridization detection procedures were illustrated in FIG. 16. The gold electrode was polished with a 0.3 μm alumina slurry on a microcloth pad (Buehler, Ill.) for 3-5 min. The electrode was next sonicated in water for a few minutes. The electrode was then electrochemically cleaned in 0.5 M of H₂SO₄ (by cycling between −0.2 V and 0.85 V versus a Pt quasi-reference electrode for 60 cycles) to ensure a complete removal of contaminants on the electrode surface. Immediately after cleaning, the electrode was rinsed with water, and incubated with 1 μM of thiolated oligonucleotide probe in 1 M of KH₂PO₄ (pH 4.5) for 10 min. The electrode was then rinsed with water. To ensure a high hybridization efficiency, the electrode was exposed to 1 mM of MCH for 1 h, followed by washing with water. This DNA/MCH-immobilized gold electrode was placed in contact with the target DNA dissolved in 10 mM of Tris-HCl/1.0 mM of EDTA/1.0 M of NaCl for hybridization at room temperature to form the ds-DNA. After 1 h, the electrode was rinsed with 10 mM of Tris-HCl/0.15 M of NaCl (pH 8.8), followed by 2×SSC buffer/0.2% of SDS. The electrode was rinsed again with 10 mM of Tris-HCl/0.15 M of NaCl (pH 8.8). This electrode was then exposed to the doxorubicin-conjugated Ag nanoparticle solution (pH 7.0, dissolved in 10 mM of Tris buffer solution) for 20 min, allowing for doxorubicin to be intercalated in the ds-DNA. The electrode was washed carefully with 10 mM of Tris-HCl/0.15 M of NaCl (pH 8.8) and with 0.1 M of KCl consecutively before performing cyclic voltammetric studies at a scan rate of 0.1 Vs⁻¹.

### Results and Discussion

### Detection of Ag Nanoparticle Labels Using Solid-State Voltammetry

Cyclic voltammetric measurements were first conducted in 0.3 M of KNO₃. However, no obvious signals related to Ag Oxidation/Reduction were observed from 0 V to 1.2 V presumably due to the strong protection of the Ag nanoparticles by the capping agent and the fact that linear sweep stripping voltammetry is less sensitive compared to the solid-state voltammetry for Ag detection. In contrast, when the voltammetric experiments were conducted in 0.3 M of KCl, two well-defined current peaks were observed in FIG. 17. In the anodic potential sweep, a very sluggish process was observed between 0.4 V and 0.7 V, corresponding to the oxidation of Ag nanoparticles. Due to the formation of AgCl, the oxidation of Ag nanoparticles became much easier. In the presence of Cl⁻, the electrogenerated Ag⁺ formed insoluble AgCl on the electrode surface. In the reverse cathodic potential scan, AgCl was reduced to Ag, and Cl⁻ was simultaneously released into the solution. A sharp peak with a peak width at half height of about 18 mV was observed at 0.122 V. This peak width was much narrower than those associated with other voltammetric processes.

The concentration of the target DNA determined the amount of nanoparticle labels bound to the hybridized double-stranded DNA (ds-DNA), which in turn established the peak magnitude, allowing for the quantification of the target DNA. It was found that process represented by Equation 2 produced a much larger peak current. Moreover, the signal produced from this process is easily distinguished from the background signal the background signal which makes the background subtraction straightforward. Therefore, the well-defined and sharp peak generated by the process represented by Equation 2 is employed for DNA sensing.

### Effect of KCl Concentration

It is expected from Equation 2 that the characteristics of the solid-state Ag/AgCl process are affected by the concentration of Cl⁻. To investigate the effect of KCl, especially on the peak width and peak height of the solid-state Ag/AgCl process, voltammetric experiments were conducted on solutions containing different amounts of KCl (0.08 to 1 M).

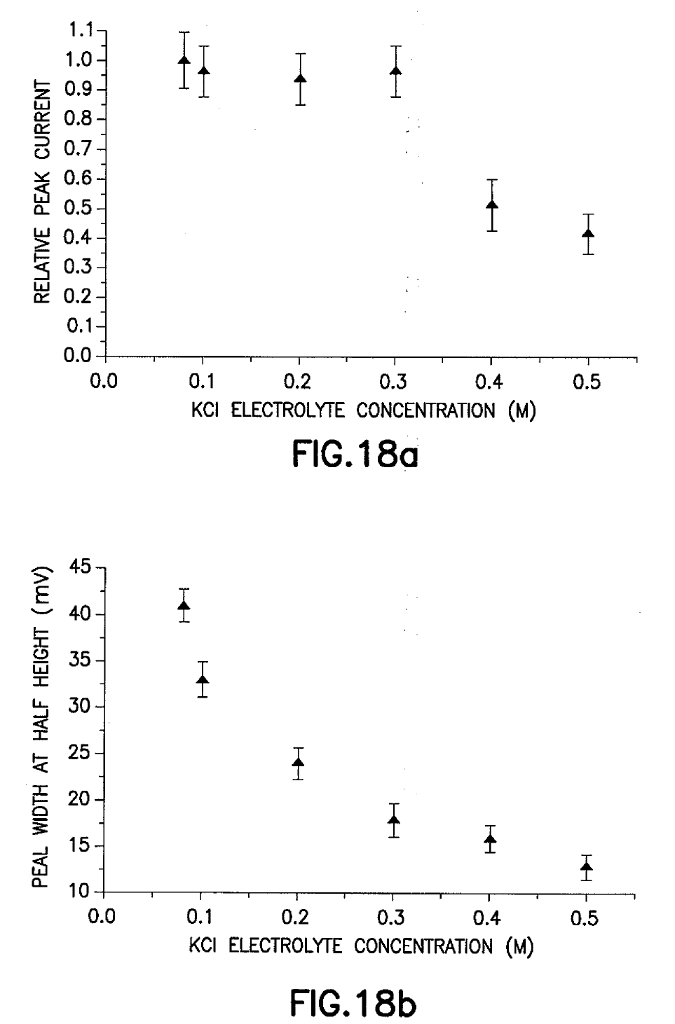

The average values of the peak width at half height and the peak current for six parallel experiments conducted for the measurement of 10 nM of target DNA were summarized in FIG. 18. The relative standard deviation (RSD) for each of these data points was about 10-15%. The results indicated that the peak width at half height became smaller at a higher KCl concentration; the maximum peak current was also significantly reduced when the KCl concentration was greater than or equal to 0.4 M of KCl. Therefore, 0.3 M of KCl was chosen for this experiment.

### Effect of the Surface Density of Immobilized DNA Probes on the Sensitivity of the Biosensor

The surface density of immobilized DNA probes has a profound effect on the hybridization efficiency with the target DNA. When the probe density is too high, hybridization efficiency is reduced. The greatest hybridization efficiency is achieved when the electrode surface is exposed to 1 μM of thiolated DNA for 120 min, followed by 1 mM of MCH for 60 min. The surface density of the probes is about 5.2×10¹² molecules/cm² under these conditions. The surface density of the DNA probes could also affect the efficiency of labeling since the Ag nanoparticles have a typical size of 5 nm, instead of Angstroms as in the case of a molecule. The labeling efficiency is expected to decrease once the density of probe is too high due to the steric hindrance effect. Therefore, experiments were conducted to examine the effect of probe density on the sensitivity of the biosensor. The probe density was varied by changing the immobilization period, while keeping the duration for the MCH step constant at 60 min. The results suggested that the highest sensitivity was obtained when a clean Au electrode was incubated with thiolated probe DNA for 10 min.

### The Effect of Doxorubicin Loading on the Sensitivity

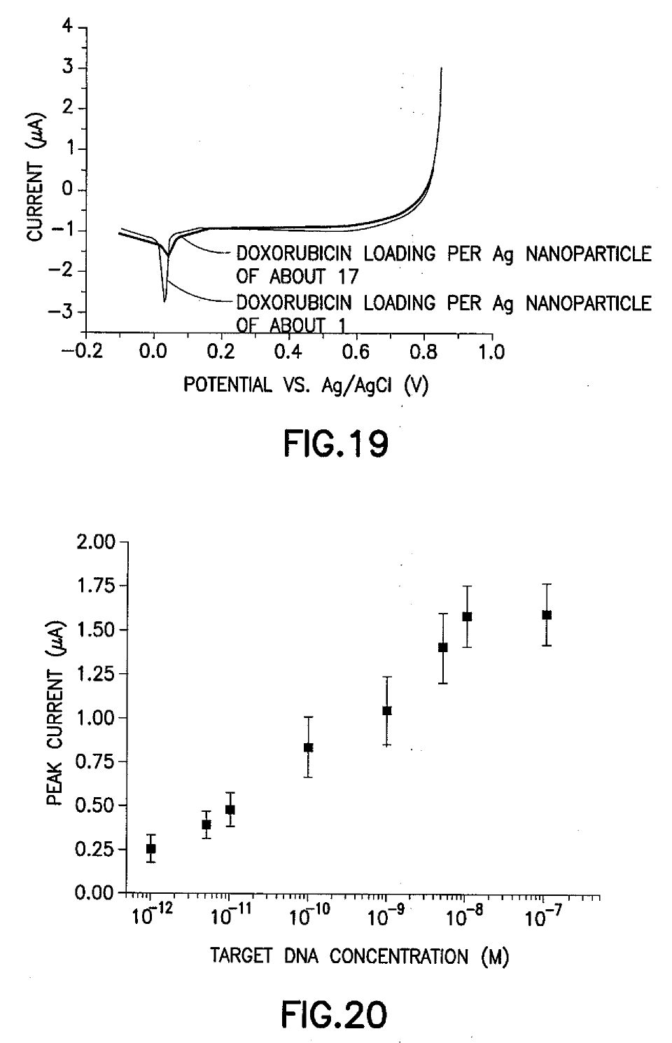

As mentioned earlier, the sensitivity of biosensor depends on the labeling efficiency with the target DNA. The labeling method for this experiment involves the intercalation of doxorubicin with the ds-DNA. Therefore, experiments were also conducted to examine the effect of doxorubicin loading per nanoparticle on the sensitivity of the DNA biosensor. Results indicated that the highest sensitivity was achieved when the doxorubicin loading per nanoparticle was about 1. When the doxorubicin loading per nanoparticle was much higher than 1, the sensitivity would decrease. As shown in FIG. 19, at a loading of about 17 doxorubicin per Ag nanoparticle, intercalation was highly unfavorable, presumably due to the fact that having an overwhelming amount of doxorubicin on the Ag nanoparticles presented a steric hindrance to intercalation with the ds-DNA on the electrode.

### Calibration Curve for DNA Detection

Under the optimal conditions, this biosensor has a good response to DNA over a wide range of concentrations. A calibration curve and the error bars taken as one standard deviation associated with each measurement obtained from six parallel experiments were shown in FIG. 20. A RSD of up to about 30% was associated with the measurements when the concentration of DNA was 1 pM. This RSD could be as small as about 10% when the DNA concentration was higher than 10 nM. As a result of the absorption isotherm, the peak current increased linearly with the logarithm of the target DNA concentration as the DNA concentration was increased from 1 pM to 10 nM. The lowest detectable concentration of 1 pM was taken as the detection limit. The peak current approached a plateau when the target DNA concentration was greater than or equal to 10 nM. Controlled experiments with non-complementary DNA showed negligible response comparable to that of a blank solution.

Doxorubicin-conjugated Ag nanoparticles as electroactive labels utilized in the electrochemical detection of DNA using the thiolated DNA probe modified gold electrode have been successfully demonstrated. These Ag nanoparticle labels were detected through the highly characteristic solid-state Ag/AgCl redox process. The derived ultrasensitive DNA biosensor operated in a simple and yet effective manner to achieve a low detection limit of 1 pM.

Although the foregoing invention has been described in some detail by way of illustration and example, and with regard to one or more embodiments, for the purposes of clarity of understanding, it is readily apparent to those of ordinary skill in the art in light of the teachings of this invention that certain changes, variations and modifications may be made thereto without departing from the spirit or scope of the invention as described in the appended claims.

1. A method for detecting the presence of a target biomolecule in a sample, comprising:
contacting the sample with a modified electrode, wherein the modified electrode has a biomolecule-specific probe immobilized on its surface and the biomolecule-specific probe is capable of forming a first complex with the target biomolecule present in the sample;
contacting the modified electrode with an electroactive label having a binding affinity to the target biomolecule to form a second complex, wherein the second complex comprises the first complex with the target biomolecule and the bound electroactive label, and whereby the modified electrode thus formed constitutes a working electrode;
placing the working electrode in an electrolyte medium; and
taking electrochemical measurement between the working electrode and a reference electrode
wherein the electrochemical measurement comprises the measurement of electrical signal resulting from a solid-state electrochemical process involving the electroactive labels and whereby the magnitude of the electrochemical measurement corresponds to the concentration of the target biomolecule present in the sample.

2. The method recited in claim 1, wherein the solid-state electrochemical process is Ag/AgCl redox process and the reference electrode is Ag/AgCl.

3. The method recited in claim 1, wherein the electroactive labels are selected from the group consisting of metals, metallic compounds, quantum dots and the conjugated-counterparts thereof.

4. The method recited in claim 3, wherein the electroactive labels are silver metal.

5. The method recited in claim 3, wherein the electroactive labels are doxorubicin-conjugated silver.

6. The method recited in claim 3, wherein the electroactive labels are antibody-conjugated silver.

7. The method recited in claim 1, wherein the electroactive labels are between 3-5 nm in diameter.

8. The method recited in claim 1, wherein the target biomolecule is a single-stranded DNA having a first sequence.

9. The method recited in claim 8, wherein the biomolecule-specific probe molecule is a neutral PNA having a second sequence complementary to the first sequence of the single-stranded DNA.

10. The method recited in claim 8, wherein the biomolecule-specific probe molecule is a single-stranded DNA having a second sequence complementary to the first sequence of the single-stranded DNA.

11. The method recited in claim 1, wherein the target biomolecule is an antigen.

12. The method recited in claim 11, wherein the target biomolecule is a prostate-specific antigen.

13. The method recited in claim 11, wherein the biomolecule-specific probe molecule is an antibody.

14. The method recited in claim 1, wherein the modified electrode further has a spacer molecule immobilized on the surface of the modified electrode prior to contacting the modified electrode with the electroactive label.

15. The method recited in claim 1, wherein the electrolyte medium is KCl.

16. The method recited in claim 1, wherein the electrode is a gold electrode.

17. (canceled)

18. An electrode for use in the detection of the presence of a target biomolecule in a sample, comprising a biomolecule-specific probe immobilized on a surface of the electrode wherein the biomolecule-specific probe is capable of forming a first complex with the target biomolecule present in the sample.

19. An electrode recited in claim 18, further comprising:
a second complex, wherein the second complex comprises the first complex with the target biomolecule and an electroactive label bound to the first complex with the target biomolecule.

20. A biosensor for detecting the presence of a target biomolecule in a sample, the biosensor comprising:
an electrode comprising a biomolecule-specific probe immobilized on a surface of the electrode wherein the biomolecule-specific probe is capable of forming a first complex with the target biomolecule present in the sample, and further comprising a second complex, wherein the second complex comprises the first complex with the target biomolecule and an electroactive label bound to the first complex with the target biomolecule, the electrode being placed in an electrolyte medium; and
an electrochemical measuring device for taking electrochemical measurement between the electrode and a reference electrode
wherein the electrochemical measurement comprises the measurement of electrical signal resulting from a solid-state electrochemical process involving the electroactive labels and whereby the magnitude of the electrochemical measurement corresponds to the concentration of the target biomolecule present in the sample.
